(19) United States
(12) Patent Application Publication
(10) Pub. No.: US 2023/0029105 A1
(43) Pub. Date: Jan. 26, 2023

(54) FINGERTIP LIDAR SYSTEM FOR VISUAL ASSISTANCE

(71) Applicant: Seagate Technology LLC, Fremont, CA (US)

(72) Inventor: Kevin A. Gomez, Minneapolis, MN (US)

(21) Appl. No.: 17/869,891

(22) Filed: Jul. 21, 2022

Related U.S. Application Data
(60) Provisional application No. 63/224,148, filed on Jul. 21, 2021.

(51) Int. Cl. G06F 3/01; G01S 17/88; G01S 17/42; G06F 3/16; G01S 7/481

(52) U.S. Cl. CPC G06F 3/014; G01S 17/88; G01S 17/42; G06F 3/017; G06F 3/016; G06F 3/167; G01S 7/4813

(57) ABSTRACT

Method and apparatus for using light detection and ranging (LiDAR) to assist the visually impaired. In some embodiments, a LiDAR system is affixed to a selected finger of a user and used to emit light pulses within a field of view (FoV) before the user. Reflected pulses are detected to generate a point cloud representation of the FoV. A sensory input is provided to the user that describes the point cloud representation of the FoV. The sensory input may be haptic, auditory or some other form. In some cases, a glove is worn by the user and a separate LiDAR system is affixed to each finger portion of the glove to provide a composite scanning and detection operation. Preconfigured hand gestures by the user can be used to change the operational configuration of the system.

### RELATED APPLICATION

The present application makes a claim of domestic priority to U.S. Provisional Patent Application No. 63/224,148 filed Jul. 21, 2021, the contents of which are hereby incorporated by reference.

### SUMMARY

Various embodiments of the present disclosure are generally directed to systems and methods for enhancing spatial sensing by an individual using active light detection and ranging (LiDAR) techniques.

Without limitation, some embodiments involve the affixing of a LiDAR system to a selected finger of a user. The LiDAR system is used to emit light pulses within a field of view (FoV) before the user. Reflected pulses are detected to generate a point cloud representation of the FoV. A sensory input is provided to the user that describes the point cloud representation of the FoV. The sensory input may be haptic, auditory or some other form. In some cases, a glove is worn by the user and a separate LiDAR system is affixed to each finger portion of the glove to provide a composite scanning and detection operation. In further cases, preconfigured hand gestures by the user can be used to change the operational configuration of the system.

These and other features and advantages of various embodiments can be understood from a review of the following detailed description in conjunction with the accompanying drawings.

### BRIEF DESCRIPTION OF THE DRAWINGS

FIG. 1 is a block representation of a light based ranging system constructed and operated in accordance with various embodiments of the present disclosure.

FIG. 2 shows an emitter of the system of FIG. 1 in some embodiments.

FIG. 3 shows an output system that can be used by various embodiments.

FIG. 4 shows a detector of the system in some embodiments.

FIG. 5 illustrates a hand based detection system in accordance with various embodiments.

FIG. 6 shows the system of FIG. 5 adapted to provide a haptic input to the user.

FIG. 7 shows the system of FIG. 5 adapted to provide an auditory input to the user.

FIG. 8 represents aspects of a visual cortex of the user in some embodiments.

FIG. 9A shows another hand based detection system in accordance with further embodiments.

FIG. 9B illustrates a point cloud representation of a composite field of view (FoV) generated by the system of FIG. 9A.

FIG. 10 is a pulse transmission and decoding sequence carried out in accordance with some embodiments.

FIG. 11 shows a hand based detection sequence carried out in accordance with some embodiments.

FIG. 12 shows aspects of an adaptive scan management system constructed and operated in accordance with further embodiments.

### DETAILED DESCRIPTION

Various embodiments of the present disclosure are generally directed to the adaptation and use of an active light detection system to enhance spatial perception by a user.

Light Detection and Ranging (LiDAR) systems are useful in a number of applications in which range information (e.g., distance, etc.) from an emitter to a target are detected by irradiating the target with electromagnetic radiation in the form of light. The range is detected in relation to timing characteristics of reflected light received back by the system. LiDAR applications include topographical mapping, guidance, surveying, and so on. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1500 nm or more). Other wavelength ranges can be used. Light is a particularly useful transport mechanism to transmit and receive range information.

One commonly employed form of LiDAR is sometimes referred to as coherent pulsed LiDAR, which generally uses coherent light and detects the range based on detecting phase differences in the reflected light. Such systems may use a dual (IQ) channel detector with an I (in-phase) channel and a Q (quadrature) channel. Other forms of LiDAR systems can be used, however, including non-coherent light systems that may incorporate one or more detection channels. Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, and so on.

Various embodiments of the present disclosure provide a method and apparatus for using LiDAR systems to aid visually impaired individuals. As explained below, a low cost, unobtrusive virtual cane system is provided for users with reduced or no eyesight capabilities. Recent advances in LiDAR sensor technology have resulted in the capability of providing single chip LiDAR sensors with exceedingly small dimensions and power consumption requirements. Without limitation, some devices of the present art can provide sensors with dimensions on the order of around 5 mm (millimeters) by 2.5 mm by 1.6 mm or smaller, and with range capabilities of around 4 m (meters) and having sample rates on the order of several tens of Hz (e.g., 20-80 Hz) or more.

Various embodiments disclosed herein provide one or more LiDAR sensors for each of a number of finger tips of the user. In one approach, a glove that can be worn on the hand of a user is provided with LiDAR sensors on some or all of the fingers of the glove. A user sensor is coupled to each of the LiDAR sensors to provide the user with sensory feedback. Examples include a haptic sensor, an auditory sensor, etc. The user sensors provide a range value at a suitable frequency at a location pointed to by the finger, and may send this information to a processing unit.

The processing unit interprets the range information and provides a waveform to drive the associated user sensor (such as a haptic or auditory transducer) that is representative of the distance and texture of the target being sensed.

The LiDAR sensors can individually scan the surrounding environment in response to the user pointing a finger or otherwise making a motion with the LiDAR sensors. A waveform feedback loop allows the user to learn to map and sense the environment. In some cases, it is possible to adapt the virtual cortex of the user so as to interpret the input as a visual input.

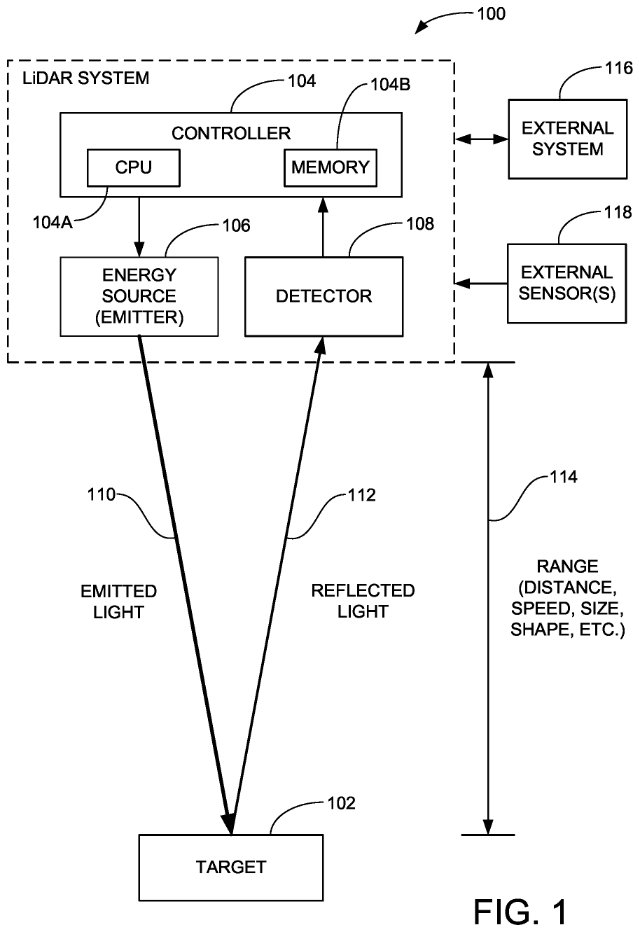

These and other features and advantages of various embodiments can be understood beginning with a review of FIG. 1 which provides a LiDAR system 100 constructed and operated in accordance with some embodiments. The LiDAR system 100 is configured to obtain range information regarding a target 102 that is located distal from the system 100. The LiDAR system 100 is shown to include a controller 104, which provides top level control of the system. The controller 104 can take any number of desired configurations, including hardware and/or software. In some cases, the controller can include the use of one or more programmable processors such as CPU 104A with associated programming (e.g., software, firmware) which provides executable instructions stored in local memory 104B. Other forms of controllers can be used, including digital signal processors (DSPs), field effect programmable gate arrays (FPGAs), system on chip (SOC) integrated circuits, application specific integrated circuits (ASICs), gate logic, etc.

An energy source circuit 106, also sometimes referred to as an emitter, operates to direct electromagnetic radiation in the form of light towards the target 102. A detector circuit 108 senses reflected light that is received back from the target 102. The controller 104 both directs operation of the emitted light from the emitter 106, denoted by arrow 110, and decodes information from the reflected light obtained back from the target, as denoted by arrow 112.

Arrow 114 depicts the actual, true range information associated with the intervening distance between the LiDAR system 100 and the target 102. Depending on the configuration of the system, the range information (range data) can include the relative or absolute speed, distance, size and other characteristics of the target 102 with respect to the system 100. Optimally, the system 100 is configured to be able to determine, with acceptable levels of accuracy, the true range data 114.

The system 100 can be integrated with an external system 116 which provides commands, inputs and other information thereto and which can receive range information therefrom. An external sensor 118 can similarly provide information to the LiDAR system 100 as well as to the external system 116. Other configurations can be used.

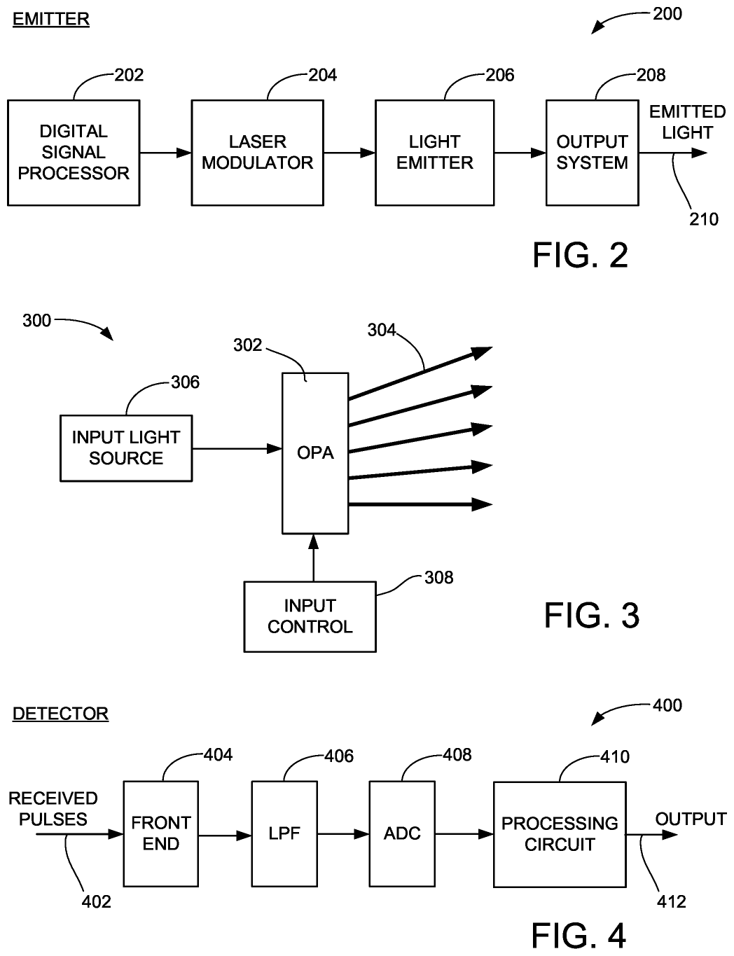

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIG. 3 shows one type of output system that can be used by the system of FIG. 2. Other arrangements can be used. FIG. 3 shows a system 300 with a solid state array in the form of an optical phase array (OPA) 302. The OPA is an integrated circuit (IC) device configured to emit light beams 304 at one or more selected angles across a desired field of view (FoV). The light beams 304 are generated responsive to an input light beam 306 and input control circuit 308, as generally depicted in FIG. 2. An OPA such as 302 is particularly suitable for use in various embodiments, but such is not necessarily required.

Regardless the configuration of the output system, FIG. 4 provides a generalized representation of a detector circuit 400 configured to process reflected light issued by the system of FIG. 2. As before, other arrangements can be used.

The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

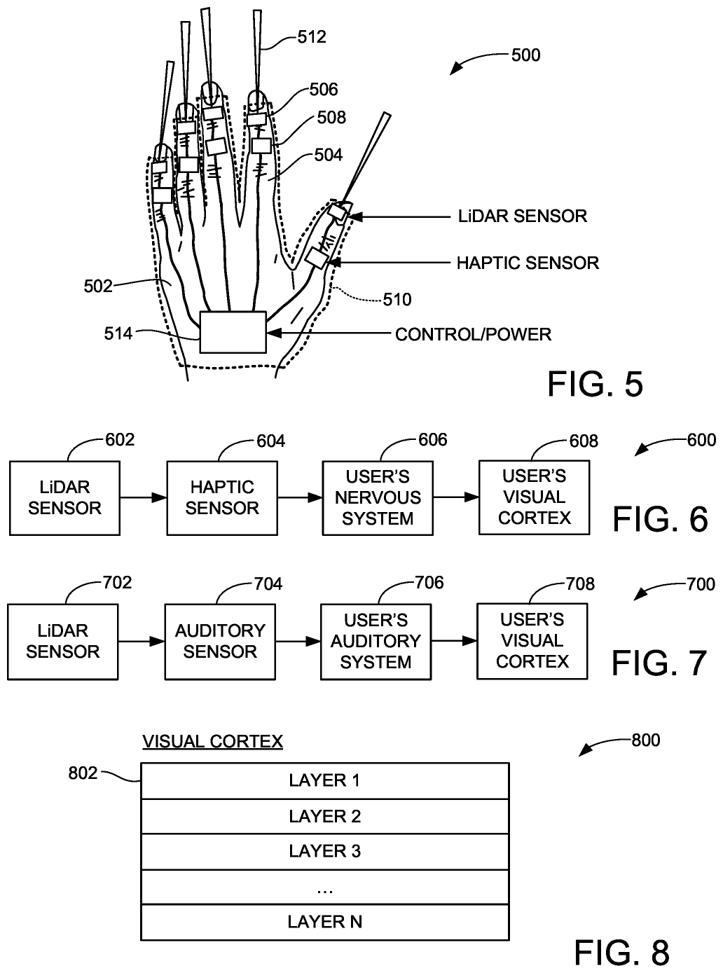

FIG. 5 depicts a LiDAR processing system 500 in accordance with various embodiments. The system 500 is characterized as a hand-held system adapted to be worn or otherwise supported by a hand 502 of a human user. In some cases, two such systems can be used, with one on each hand of the user. While mounting and manipulation of the system in a hand-held manner is contemplated, other arrangements are contemplated. It is contemplated albeit not necessarily required that the system be configured so that the user is able to physically manipulate the device (e.g., direct it over a desired FoV).

The system 500 includes various elements that are mounted to or otherwise secured adjacent individual fingers 504 of the user's hand. These can include all of the user's fingers (e.g., four fingers and thumb) or a selected subset of these members. The elements include a LiDAR sensor 506 and a corresponding user sensor 508. The respective sensors 506, 508 are affixed to or incorporated within a glove 510 that is fashioned to be worn on the hand of the user. The sensors 506, 508 may be coupled to a central processing unit 514 which can be mounted in a suitable location on the glove 510 as shown. Other arrangements can be used.

The LiDAR sensor 506 for each finger may be arranged to emit light beams (represented at 512) using emitter circuitry as described in FIG. 2. While not limiting, each LiDAR sensor 506 is contemplated as using one or more OPA devices such as depicted at 302 in FIG. 3, we well as a detector circuit 400 as further provided in FIG. 4. As noted above, a solid-state approach is used such that the LiDAR sensors 506 may each be incorporated into a relatively small IC package.

The user sensors 508 can take a variety of forms. In some cases, the user sensors 508 are haptic sensors that incorporate a haptic transducer that provides a vibratory output that can be sensed by the user. Other forms of user sensors are contemplated, including but not limited to audible (auditory) sensors. In some cases, multiple different types of user sensors are used in the same system.

The use of multiple LiDAR sensors 506 and user sensors 508 provide a complex, multi-layered response for the user; for example, each LiDAR sensor 506 can be pointed in a different direction based on the orientation of the associated finger to map a large area (e.g., a room, an outdoor space, etc.). Fingertip control allows the FoV for each finger to be slightly different and continuously adjusted.

It is contemplated albeit not necessarily required that the user sensor 508 for each finger will provide a user response that maps the detected environment by the associated LiDAR sensor 506 for that finger. In this way, separate channels are generated; the sensing by the thumb LiDAR sensor 506 is output to the user by the haptic sensor 508 on the thumb, the sensing by the pinky finger LiDAR sensor 506 is output to the user by the haptic sensor 508 on the pinky finger, and so on.

However, in further embodiments, consolidated sensing and reporting techniques can be used so that, for example, signals from a first sensor (e.g., the LiDAR sensor 506 on the index finger of the hand) can be transmitted to some or all of the user sensors 508 for other fingers. Weighting and other factors can be used; for example, the user may have a preference to receive primary sensing from a particular set of fingers (such as the index and middle fingers, etc.), so these signals are processed and are provided greater sensitivity in the output haptic response by the associated sensors. Other configurations can be used.

It is contemplated that a wired connection will be supplied and incorporated into the glove 510 between the respective active elements 506, 508 and 514. These can include metallic conductive paths, flex circuits, waveguides, etc. However, this is not necessarily required, as wireless data and control paths can be used. While not limiting, the system is contemplated as being battery powered including through the use of one or more rechargeable batteries incorporated into the processing unit 514 to supply power to the respective sensors 506, 508.

In some cases, the LiDAR sensors 506 can be substantially the emitter and front end detector devices and the complex detector signal processing operations can be carried out at the processing unit stage 514. Once processed, the output haptic signals can be forwarded from the processing unit 514 to the individual haptic user sensors 508. Other arrangements can be used, including other locations for the various sensors and processing unit. In another embodiment, a glove-type arrangement is provided as in FIG. 5, but only a single LiDAR sensor 506 and single haptic sensor 508 is provided, such as at the distal end of the index finger.

In yet another embodiment, the LiDAR sensor(s) and the user sensor(s) are incorporated into an article of clothing, an article of jewelry (e.g., a pendant, a ring, a bracelet, etc.), and so on. Multiple gloves can be worn by the user each with separate or integrated sensing and processing capabilities. The fingertips of the gloves are shown to be exposed, enabling the user to otherwise touch and sense objects normally.

FIG. 6 shows a system 600 corresponding to the system 500 in FIG. 5 in accordance with some embodiments. The system 600 includes each of a plurality of LiDAR sensors 602, such as but not limited to one per finger. The LiDAR sensors 602 each independently operate as discussed above to generate range information which is provided to a corresponding haptic sensor 604. Each associated haptic sensor 604 generates vibratory or similar inputs which are detected by the nervous system 606 of the user, such as through nerve endings adjacent each of the user's fingers. As noted above, other locations for the sensors can be used.

The inputs supplied to the nervous system 606 may be transferred to a visual cortex 608 of the user, which will be understood as a portion of the brain of the user that is normally adapted to process visual information. In a user with impaired sight capabilities, it is contemplated that such inputs can be repurposed to enable the user to gain a spatial understanding of the surrounding area about the user's locale.

FIG. 7 shows another system 700 corresponding to the system 500 in FIG. 5 in accordance with further embodiments. The system 700 is similar to the system 600 except that an auditory response, rather than a haptic response, is supplied to the user. It will be appreciated that other systems can provide both haptic and auditory responses, or other types or combinations of sensory inputs to the user.

The system 700 includes a LiDAR sensor 702, such as on each of one or more fingers of the user as described above. Outputs from each sensor 702 are supplied to one or more auditory sensors 704, which are adapted to emit auditory signals at various frequencies responsive to the LiDAR inputs. As before, an auditory system 706 of the user can be adapted to detect the output from the user sensors 704, and the user's visual cortex 708 can map these inputs, over time after suitable training, to detect a field of view type of mapping of the surrounding area.

FIG. 8 is a simplified representation of aspects of the visual cortex 800 of a user in some embodiments. It will be understood that it is not necessarily required that the visual cortex of the user be engaged in order to cover aspects of the present disclosure. Nonetheless, it is contemplated that this is a particularly useful application of various embodiments.

The visual cortex 800 includes various layers 802 identified as layers 1 through N. Each subsequent layer may provide more detailed information, including based on other information stored in the brain of the user, so that as inputs are supplied from the systems such as in FIGS. 5-7, different layers may be accessed to provide cognition of the surrounding environment.

It has been found that, with suitable training including controlled inputs and outputs, humans can utilize haptic and/or auditory inputs such as provided by various embodiments to map the surrounding environment. In some cases, each sensor 506 can be used to provide a unique set of waveform characteristics such that the system can distinguish among the different pulses transmitted and received from the individual sensors.

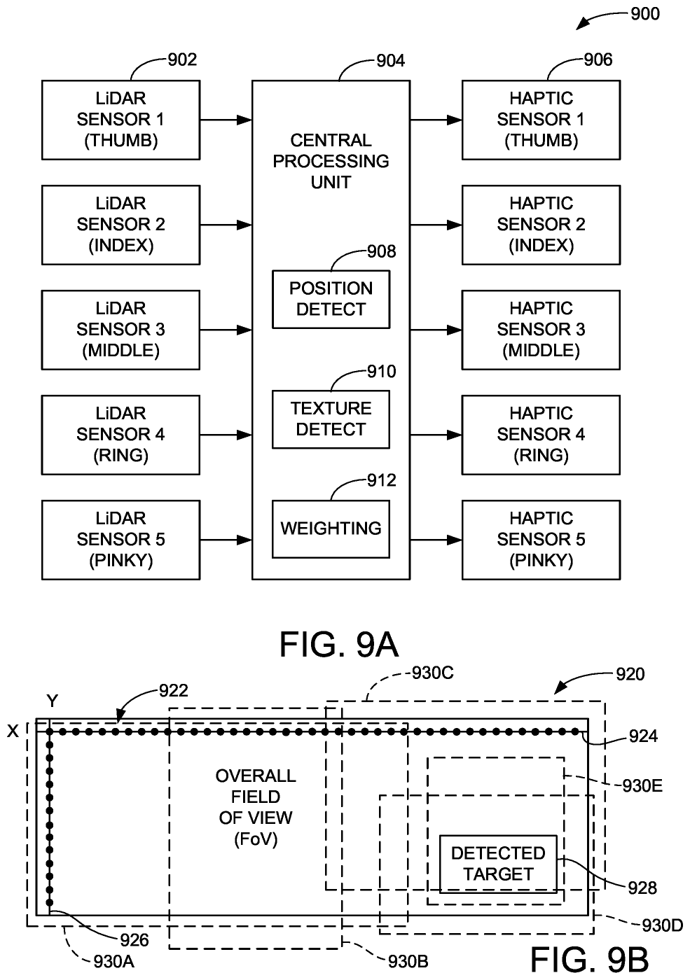

FIG. 9A is a functional block representation of another LiDAR processing system 900 in accordance with further embodiments. The system 900 is similar to the system 500 described above in FIG. 5, in that the system 900 includes five (5) LiDAR sensors 902 each coupled to a separate finger of a user (e.g., thumb, index, middle, ring and pinky). The system 900 can be glove mounted as before, although such is merely exemplary and is not necessarily required. In some cases, the system can incorporate two gloves, one for each hand, with separate or integrated operation (including wireless communications between the respective gloves).

Each sensor 902 can emit light pulses at a different frequency/wavelength as desired. In some cases, each sensor provides slightly different wavelengths. The values/ranges of the various multiple wavelengths of the emitted light pulses can vary depending on the requirements of a given application. In some embodiments, the differential ranges of values output by each laser may be on the order of from about 5-10 nm, although other ranges can be used. For clarity, all of the wavelengths may be centered around some nominal operational LiDAR wavelength (e.g., 850 nm, 1550 nm, etc.).

In an alternative embodiment, a single light source (including but not limited to a frequency comb) can be incorporated into the processing unit and flexible waveguides (e.g., fiber optics, etc.) can be used to transport the light to each output sensor. Detection optics, photodetectors, etc. can further be supplied at each finger tip in each sensor for detection purposes (as part of the detector front end).

The respective sensors 902 scan the surrounding environment as before and supply output signals responsive to detected reflected light pulses to a central processing unit 904. The unit 904 operates as described above to interpret and build a 3D point cloud representation of the sensed environment, and to provide associated outputs to various haptic sensors 906 for sensory receipt by the user.

In some embodiments, the unit 906 includes additional circuits including a position detection circuit 908, a texture detection circuit 910 and a weighting circuit 912. As noted above, the unit 904 can be realized using hardware, software and/or firmware, and can incorporate one or more programmable processors that execute program instructions in a memory (as in FIG. 1) or one or more hardware processors formed of gate logic or other structures.

The position detection circuit 908 interprets different configurations of the glove by the user. These positions can be determined using external sensors affixed to the glove (see e.g., FIG. 1) or can be determined by the different relative orientations of the LiDAR sensors 902 (e.g., a “gun” orientation by the hand of the user would tend to point the index finger forward, the thumb straight upward, and the remaining fingers curled into the palm of the hand). A number of different relative orientations such as this can be sensed by the unit, and such can be interpreted as commands to the system.

In the present example, such a “gun” orientation can operate to change the parametric configuration of the system to use a different distance, different resolution, etc., enabling the user to obtain different response characteristics from the system based on hand orientation. Similarly, pointing all five fingers forward so as to be nominally parallel in a “cup” shape can be interpreted to provide a different system response, and so on. Any number of different changes in operation can be detected based on different gestures/hand orientations supplied by the user and detected automatically in relation to the response provided by the respective LiDAR sensors.

The texture detection circuit 910 can operate based on the reflected light from the respective sensors to indicate a particular texture of the sensed surface (e.g., smooth, rough, etc.). An accompanying hand gesture (such as sweeping movement of the fingers together, etc.) can be used to activate the system to enhance texture detection over and above the normal capability of the system during otherwise normal operation.

The weighting circuit 910 can operate to change the weighting of different sensors, which can be particularly useful when the fingers are pointing in different directions. For example, the pinky finger may tend to be pointed downwardly while the index and middle fingers may tend to be pointed forward in a direction of travel; in this case, greater weight may be applied to the signals generated by or received from the latter sensors as compared to the former.

While FIG. 9A shows five (5) LiDAR sensors 902 and five (5) corresponding user sensors 906, other respective numbers of each of these sensors can be used. For example, multiple LiDAR sensors can feed a single user sensor and vice versa. Moreover, the LiDAR sensors 902 can be affixed to the various fingers of the user, but the user sensors 906 can be located elsewhere; for example, a set of headphones can be used as the user sensors coupled to the auditory system of the user (e.g., placed within the user's ears), a vibratory pad can be placed on substantially any skin surface of the user to access the user's nervous system (e.g., to provide vibrations thereto), and so on.

FIG. 9B shows a corresponding response 920 generated by the system 900 of FIG. 9A. The response is characterized as a three-dimensional (3D) point cloud representation of the surrounding environment within an associated field of view (FoV). The response is generated by light beams/points 922 that are generated by the respective sensors 902 and which scan the FoV 920 as shown. The scanning directions can be in a single direction or along multiple directions (e.g. orthogonal x-y axes 924, 926) in a rasterized pattern. In some cases, one sensor 902 (such as the index finger sensor) can scan in a first direction, such as vertically, and a different sensor 902 (such as the middle finger sensor) can scan in a second direction, such as horizontally.

A detected target within the FoV 920 is denoted at 928. In some cases, increased user response (e.g., greater amplitude vibrations/tones) can be generated as the user directs and acquires the target 928 by manipulating a finger, or multiple fingers, so as to point to the target.

It will be noted that the overall FoV 920 can be characterized as a composite FoV made up of sensor inputs supplied by each of the different LiDAR sensors 902 in FIG. 9A. By way of illustration, areas 930A through 930E can be understood as different fields of view provided by the different LiDAR sensors 902 in FIG. 9A from each finger portion of the glove (e.g., thumb, index, middle, ring and pinky sensors, respectively).

These areas overlap and can be consolidated to provide the final overall FoV 920. In some cases, points extending outside the rectilinear area defined by 920 can be ignored or utilized to expand the FoV into an irregular shape. Overlapping areas can either be given greater resolution, or one area can be given priority over another. The ability of the user to concentrate the respective scans provides the unique option of immediately increasing the point cloud density of a given area through the simple expedient of pointing more fingers at the area of interest. For example, the user has the ability to immediately focus in on the detected target 928 by pointing more fingers at the target. In some embodiments, one or more of the sensors can be given priority in the processing circuitry (for example, the index finger sensor can provide highest resolution or weighting, etc.), so that, much as the human eye can be directed to a particular area of focus, the user can utilize the LiDAR sensors 902 in a similar fashion to quickly shift between nearfield focus and broader field view.

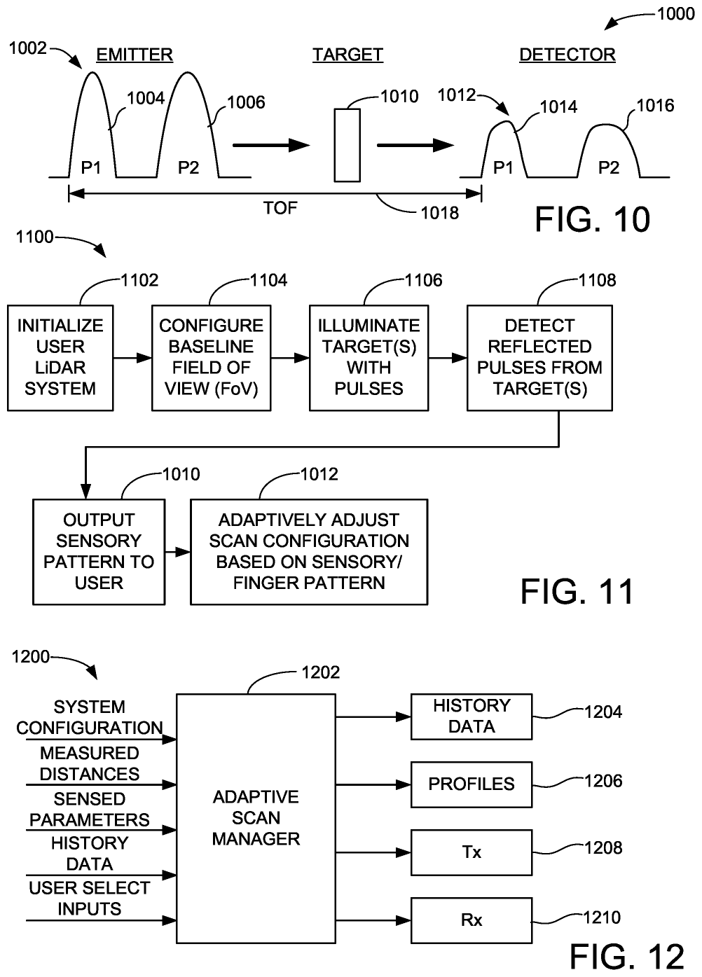

FIG. 10 depicts a pulse transmission and reflection sequence 1000 carried out in accordance with various embodiments. It will be appreciated that the sequence 1000 can represent the independent and separate operation of each of the various LiDAR sensors in a given application.

As shown by FIG. 10, an initial set of pulses is depicted at 1002 having two pulses 1004, 1006 denoted as P1 and P2. Each pulse may be provided with a different associated frequency or have other characteristics to enable differentiation by the system. The emitted pulses 1004, 1006 are quanta of electromagnetic energy that are transmitted downrange toward a target 1010.

Reflected from the target is a received set of pulses 1012 including pulses 1014 (pulse P1) and 1016 (pulse P2). The time of flight (TOF) value for pulse P1 is denoted at 1018. Similar TOF values are provided for each pulse in turn.

Depending on the distance to the target illuminated by the sensor, the received P1 pulse 1014 may undergo frequency doppler shifting and other distortions as compared to the emitted P1 pulse 1004. The same is generally true for each successive sets of transmitted and received pulses such as the P2 pulses 1006, 1016. Nevertheless, the frequencies, phase and amplitudes of the received pulses 1014, 1016 will be processed as described above to enable the detector circuit to correctly match the respective pulses and obtain accurate distance and other range information.

In some cases, the emitted/received pulses such as P1 can represent higher resolution pulses generated by a first sensor (e.g., the thumb sensor) and the emitted/received pulses such as P2 can represent lower resolution pulses from a second sensor (e.g., the pinky sensor). Other arrangements can be used. It will be appreciated that the pulses sent by the various sensors to the FoV may be interleaved or otherwise overlap, so that pulses from one sensor may be detected by a different sensor. However, using multi-channel processing and different wavelengths of pulses can enable the system to easily manage and detect the data from all of the different emitters. As such, different frequencies, wavelengths, amplitudes, gain characteristics, pulse sequence counts, and other adjustments can be made to distinguish and process the respective pulses in the various areas.

FIG. 11 is a sequence diagram 1100 for a scan operation carried out in accordance with various embodiments described herein. Other operational steps can be incorporated into the sequence as required, so the diagram is merely illustrative and is not limiting.

A LiDAR system such as 100, 500, 900 as described above is initialized at block 1102. An initial, baseline field of view (FoV) is selected for processing at block 1104. This will include selection and implementation of various parameters (e.g., pulse width, wavelength, raster scan information, density, etc.) to accommodate the baseline FoV. As noted previously, user inputs can be used to set the initial configuration of the scanned field.

Thereafter the system commences with normal operation at block 1106. The user moves his hand (or hands) to scan the surrounding environment. Light pulses are transmitted to illuminate various targets within the FoV using the emitters. Reflected pulses from various targets within the baseline FoV are detected at block 1108 using a detector system as described above.

An output sensory pattern is conveyed to the user at block 1010 in response to the detection operation at block 1008. As noted above, this can include haptic, auditory and/or other sensory inputs. As desired, the scan configuration is adaptively adjusted at 1012. This adjustment can take place in a variety of ways; for example, assuming a large target is sensed that is coming toward the user, greater scanning focus may be directed opon this target to provide the user with greater information regarding the same. In other cases, the user may convey a change in scanning resolution or other configuration based on a change in hand orientation (including a command gesture recognized by the system, etc.).

FIG. 12 shows an adaptive management system 1200 that can be incorporated into the system 100 of FIG. 1 in some embodiments. The system 1200 includes an adaptive scan manager circuit 1202 which operates to implement various enhanced resolution scans in selected fields of interest within a baseline FoV as described above. The manager circuit 1202 can be incorporated into the controller 104 such as a firmware routine stored in the local memory 124 and executed by the controller processor 122.

The manager circuit 1202 uses a number of inputs including system configuration information, measured distance for various targets, various other sensed parameters from the system (including external sensors 126), history data accumulated during prior operation, and user selectable inputs. Other inputs can be used as desired.

The manager circuit 1202 uses these and other inputs to provide various outputs including accumulated history data 1204 and various profiles 1206, both of which can be stored in local memory such as 124 for future reference. The history data 1204 can be arranged as a data structure providing relevant history and system configuration information. The profiles 1206 can describe different pulse set configurations with different numbers of pulses at various frequencies and other configuration settings, as well as other appropriate gain levels, ranges and slopes for different sizes, types, distances and velocities of detected targets.

The manager circuit 1202 further operates to direct various control information to an emitter (transmitter Tx) 1208 and a detector (receiver Rx) 1210 to implement these respective profiles. It will be understood that the Tx and Rx 1208, 1210 correspond to the various emitters and detectors described above. Without limitation, the inputs to the Tx 1208 can alter the pulses being emitted in the area of interest (including actuation signals to selectively switch in the specially configured lens or other optical element), and the inputs to the Rx 1210 can include gain, timing and other information to equip the detector to properly decode the pulses from the enhanced resolution area of interest.

Different gain ranges can be selected and used for different targets within the same FoV. Closer targets within the point cloud can be provided with one range with a lower slope and magnitude values to obtain optimal resolution of the closer targets, while at the same time farther targets within the point cloud can be provided with one or more different gain ranges with higher slopes and/or different magnitude values to obtain optimal resolution of the farther targets. These and other features can be readily accomplished by the multi-channel emitter and detector configurations described herein.

It can now be understood that various embodiments provide a LiDAR system with the capability of enhancing user interaction, particularly but not necessarily limited to a user having impaired vision. For example, the system can be utilized by a worker in a dark workspace, etc. Any number of different alternatives will readily occur to the skilled artisan in view of the foregoing discussion.

While coherent, I/Q based systems have been contemplated as a basic environment in which various embodiments can be practiced, such are not necessarily required. Any number of different types of systems can be employed, including solid state, mechanical, micromirror technology, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising a portable LiDAR system having at least one LiDAR sensor and a corresponding user sensor, the LiDAR sensor affixed to a selected finger of a user, the LiDAR sensor emitting light pulses within a field of view (FoV) and detecting reflected pulses therefrom to generate a point cloud representation of the FoV, the user sensor providing a sensory input to the user that describes the point cloud representation of the FoV.

2. The apparatus of claim 1, wherein the user sensor is a haptic sensor configured to be affixed adjacent a skin portion of the user and which generates a multifrequency vibratory response configured to be sensed by a nervous system of the user.

3. The apparatus of claim 1, wherein the user sensor is an auditory sensor that generates a multifrequency auditory response that is configured to be sensed by an auditory system of the user.

4. The apparatus of claim 1, further comprising a glove adapted to be worn on a hand of the user, wherein the the LiDAR sensor is affixed to the glove adjacent the finger of the user.

5. The apparatus of claim 4, wherein the finger is a first finger, and the apparatus further comprises a second LiDAR sensor affixed to the glove so as to be adjacent a different, second finger of the user.

6. The apparatus of claim 1, wherein the finger is an index finger of the user, and wherein the apparatus further comprises four additional LiDAR sensors affixed to the glove adjacent each of a middle finger, a ring finger, a pinky finger and a thumb of the user.

7. The apparatus of claim 1, further comprising a processing unit coupled to the LiDAR sensor and the user sensor configured to process the reflected pulses from the LiDAR sensor to generate the point cloud representation of the FoV and to provide an input signal to the user sensor to generate the sensory input to the user.

8. The apparatus of claim 7, wherein the LiDAR sensor generates pulses having a first nominal wavelength, wherein the apparatus comprises a different, second LiDAR sensor adjacent a different, second finger of the user, wherein the second LiDAR sensor generates pulses having a different second nominal wavelength, and wherein reflected pulses from each of the first and second LiDAR sensors are combined to generate the point-cloud representation and corresponding sensory input for the user.

9. The apparatus of claim 1, further comprising a processing unit which changes an output wavelength emitted by the LiDAR sensor responsive to an activation signal supplied to the processing unit.

10. The apparatus of claim 9, wherein the activation signal is generated responsive to a target detected within the FoV.

11. The apparatus of claim 9, wherein the activation signal is generated responsive to the user placing a hand thereof having the finger in a predetermined gesture configuration.

12. The apparatus of claim 1, further comprising a glove having five finger portions to accommodate five fingers of the user, wherein each finger portion supports a separate LiDAR sensor, and wherein the user sensor generates a consolidated sensory input to the user responsive to separate scans of the FoV by each of the separate LiDAR sensors.

13. The apparatus of claim 12, wherein each of the separate LiDAR sensors outputs light beams at a different wavelength.

14. The apparatus of claim 1, wherein the LiDAR sensor comprises an optical phase array (OPA) integrated circuit device which scans the FoV using beams having at least one wavelength.

15. A method comprising:
emitting light pulses within a field of view (FoV) from each of a plurality of a portable LiDAR sensors each affixed to a different finger of a user;
detecting reflected pulses from the emitted light pulses to generate a point cloud representation of the FoV; and
outputting a sensory signal in the form of a vibratory response to the user that describes the point cloud representation of the FoV.

16. The method of claim 15, wherein the sensory signal is supplied to a haptic device coupled to a skin portion of the user to transmit a multifrequency vibratory input to the user having components corresponding to at least one target within the FoV.

17. The method of claim 15, wherein the sensory signal is an auditory signal comprising a composite set of echolocation frequencies corresponding to at least one target within the FoV.

18. The method of claim 15, further comprising changing a waveform characteristic of the emitted light pulses responsive to at least one detected target within the FoV.

19. The method of claim 15, further comprising changing a waveform characteristic of the emitted light pulses response to a predetermined hand gesture made by the user, the hand gesture sensed responsive to an output from each of the portable LiDAR sensors.

20. The method of claim 15, further comprising applying a weighting function to the respective LiDAR sensors in relation to different angular orientations of the associated fingers of the user.
